(19) United States
(12) Patent Application Publication
(10) Pub. No.: US 2009/0054144 A1
(43) Pub. Date: Feb. 26, 2009

(54) FORCE FEEDBACK APPARATUS AND SYSTEM USING THEREOF

(75) Inventors: Ming-Tsan Peng, Taoyuan County (TW); Po-Chang Chen, Taipei County (TW)

Correspondence Address: WPAT, PC, 7225 BEVERLY ST., ANNANDALE, VA, 22003, US

(73) Assignee: INDUSTRIAL TECHNOLOGY RESEARCH INSTITUTE, Hsin-Chu (TW)

(21) Appl. No.: 11/967,210

(22) Filed: Dec. 30, 2007

(30) Foreign Application Priority Data
Aug. 24, 2007 (TW) 096131353

(51) Int. Cl. G06F 17/00

(52) U.S. Cl. 463/36

(57) ABSTRACT

A force feedback apparatus and system are provided in the present invention. The force feedback apparatus is capable of balancing the reactive force or torque generated by an actuator of the force feedback apparatus through a balance output generated by a balance controlling unit coupled to the actuator so that the force feedback apparatus can interactive with the operator without a need for connection to a fixed frame. On the other hand, the system of the present invention adopts the force feedback apparatus to be a human operating interface for allowing the operator to interact with programs executed in an electrical interactive device so as to increase the trueness of the virtual reality.

### FIELD OF THE INVENTION

The present invention relates to a human-machine interface and system, and more particularly, to a force feedback apparatus and system using thereof capable of generating an output of feedback without having to be fixedly stationed.

### BACKGROUND OF THE INVENTION

Recently, following the growing applications in home entertainment, engineering, remote mechanical control and virtue reality, force feedback apparatus is becoming more and more essential as it can increase the overall realism of a simulation by providing a sense of virtual contact. Generally, the force feedback apparatus is substantially a haptic feedback device capable of providing an operator with the feel of touch by generating and transmitting a feedback force to be felt by the operator.

Force feedback apparatuses are most commonly applied in video game industry. It is known that the physical aspect of a video game includes two aspects: Use of the real world as a gaming environment and/or use of physical objects for interaction. Nowadays, most video game manufacturers, such as Nintendo, Sony, Microsoft and Sega, are providing a gaming environment with lavish visual sensation by designing their game consoles to connect with televisions or computer monitors, which is also true for those video game especially configured for PCs and/or PDAs. Nevertheless, with the rapid advance of 3D image processing technology in game consoles, video game manufacturers now try to improve interactions between real players and character configurations in video games by designing force feedback apparatus in their user interfaces, e.g. mouse, joystick, game board, driving wheel, etc., for providing good force response in their games.

One representative gaming system is the fifth home video game console “Wii” released by Nintendo. A distinguishing feature of the Wii console is its wireless controller, the Wii Remote, which is a TV remote control sized controller capable wirelessly communicating with its game console in a manner that the game console can be direct the Wii remote to issue a force feedback response to interact with players. The Wii remote allows players to control the game using physical gestures, which not only is different from those the conventional tabletop/grounded game consoles, but also is able to detect how hard a player is playing so as to issue a force response to the player, so that it actually makes possible a new form of player interaction.

There are already many studies relating to such force feedback apparatus. One of which is a device for directional tatile sensations disclosed in U.S. Pat. No. 7,084,854. One of the embodiments shown in the aforesaid disclosure is a mouse device. As shown in FIG. 1, the housing of the mouse device includes a base portion 52, a top portion 54, and a harmonic actuator assembly 50, being coupled to a printed circuit board 56 of the base portion 52. Operationally, the actuator assembly 50 output inertial forces to the top potion 545 where it is felt by a user holding the mouse device. It is noted that actuator assembly 50 is secured to the base portion 52 through a elastic member and the mouse device can be rested on a ground surface such as a tabletop or mousepad so that the inertial force of the actuator assembly 20 is absorbed by the ground surface.

Another such study is a directional haptic feedback device for game controllers, disclosed in U.S. Pat. No. 7,182,691. The directional haptic feedback apparatus uses rotating eccentric masses to create centrifugal forces that cause directional inertial vibrations in the housing of the device, whereas the eccentric masses are driven to rotate by actuators. In an exemplary embodiment of the aforesaid disclosure, rotary shafts of the eccentric masses are arranged about parallel with each other so that a combined centrifugal force resulting from the rotation of the masses is generated. When the masses are rotating with different phase differences, different directional inertial outputs can be felt by the user holding the device, that is, the amount of phase difference determines the direction that the resultant force is output that results from the combination of the centrifugal forces from each mass.

One another such study is a gyro-stabilized platform for force feedback applications, disclosed in U.S. Pat. No. 5,754,023. In one embodiment, one or more orthogonally oriented rotating gyroscopes are used to provide a stable body or platform to which a force-reflecting device can be mounted, thereby coupling reaction forces to the user without the need for connection to a fixed frame. For instance, when the gyro-stabilized platform is formed by a set of three, mutually perpendicular momentum wheels that are rotating and there is a force exerting on the force-reflecting device that intends for enable the device to rotate, such force will be resisted by a torque generating from the three rotating wheels. In addition, it is known that the torque can be adjusted by varying the rotation speed of any one of the three momentum wheels, so that when the device is enabled to interact with a user through a linkage rod, the gyro-stabilized platform is able to provide different force feedbacks of torque to the used by adjusting the rotation speed of the three wheels without the need for connection to a fixed frame.

### SUMMARY OF THE INVENTION

The present invention is to provide a force feedback apparatus capable of balancing the reactive force or torque generated by an actuator of the force feedback apparatus through a balance output generated by a balance controlling unit coupled to the actuator so that the force feedback apparatus can interactive with the operator without a need for connection to a fixed frame.

The invention is to provide a force feedback system capable of using a force feedback apparatus as a human-machine interface to communicate with a multimedia device, such as a computer or a gaming console, and thus enabling an operator to interact with the multimedia device with high virtual reality at any occasion as the force feedback apparatus is able to issue a force feedback response to interact with operator without a need for connection to a fixed frame.

The present invention provides a force feedback apparatus, comprising: an actuator, for providing a feedback output; an operating unit, coupled to the actuator for receiving the feedback output; and a balance controlling unit, coupled to the actuator for generating a balance output to balance the reactive force generated by the feedback output.

In an embodiment of the invention, a force feedback system is provided, which comprises: an electrical interactive apparatus; and a force feedback apparatus, capable of communicating with the electrical interactive apparatus; wherein the force feedback apparatus further comprises: an actuator, for providing a feedback output; an operating unit, coupled to the actuator for receiving the feedback output; and a balance controlling unit, coupled to the actuator for generating a balance output to balance the reactive force generated by the feedback output.

Further scope of applicability of the present application will become more apparent from the detailed description given hereinafter. However, it should be understood that the detailed description and specific examples, while indicating preferred embodiments of the invention, are given by way of illustration only, since various changes and modifications within the spirit and scope of the invention will become apparent to those skilled in the art from this detailed description.

### BRIEF DESCRIPTION OF THE DRAWINGS

The present invention will become more fully understood from the detailed description given herein below and the accompanying drawings which are given by way of illustration only, and thus are not limitative of the present invention and wherein:

FIG. 1 is an exploded view of a mouse device disclosed in U.S. Pat. No. 7,084,854.

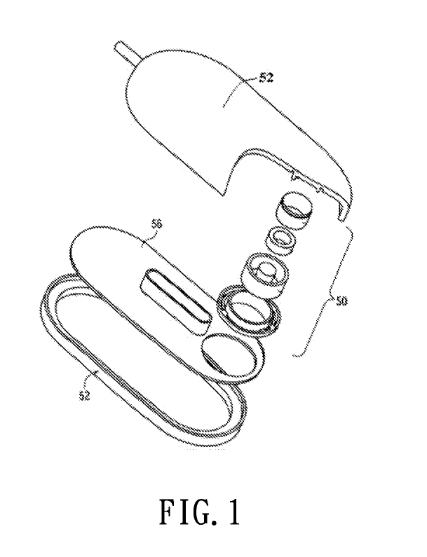

FIG. 2 is a schematic view of a force feedback apparatus according to a first embodiment of the invention.

FIG. 3 is a schematic diagram showing a balance controlling unit with tri-axial configuration, used in a force feedback apparatus of the invention.

FIG. 4 is a schematic view of a force feedback apparatus according to a second embodiment of the invention.

FIG. 5 is a schematic view of a force feedback apparatus according to a third embodiment of the invention.

FIG. 6A is a schematic view of a force feedback system of the invention.

FIG. 6B is a block diagram showing a force feedback system according to an embodiment of the invention.

FIG. 7 is a block diagram showing a force feedback system according to another embodiment of the invention.

### DESCRIPTION OF THE EXEMPLARY EMBODIMENTS

For your esteemed members of reviewing committee to further understand and recognize the fulfilled functions and structural characteristics of the invention, several exemplary embodiments cooperating with detailed description are presented as the follows.

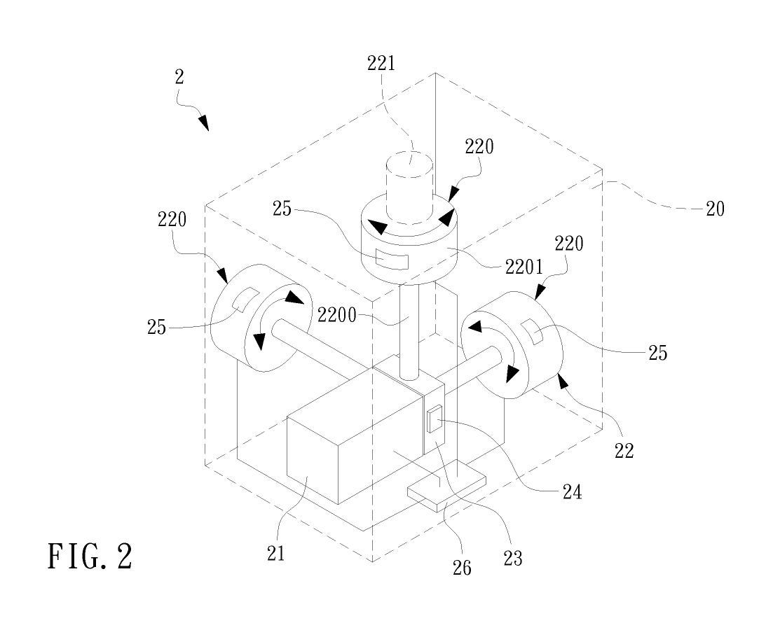

Please refer to FIG. 2, which is a schematic view of a force feedback apparatus according to a first embodiment of the invention. The force feedback apparatus 2 of FIG. 2, being received inside a housing 20, is configured to function as a human-machine interface to be used by a user for communicating with a multimedia device. That is, a user holding the housing 20 is able to interact with programs executed in the multimedia device through the force feedback apparatus 2. It is noted that such force feedback apparatus 2 can be integrated inside an interactive operation interface, such as a mouse device or a remote control. In this exemplary embodiment, the housing 20 is not secured to a fixed frame, such as a tabletop, but is being held in the user's hand to be operated just like a remote control. Operationally, the force feedback apparatus 2 is configured to drive the housing 20 for exerting a directional force upon the user's hand.

The force feedback apparatus 2 comprises an actuator 21 and a balance controlling unit 22, in which the actuator 21, being connected to the housing 20, is capable of providing a feedback output to the housing 20; and the balance controlling unit 22, being coupled to the actuator 21, is used for generating a balance output to balance the reactive force generated by the feedback output. The generation of the feedback output by the actuator 21 can be induced by the use of electricity, electromagnetic energy, material deformation, or fluid, and so on. In addition, the feedback output is able to cause a response selected from the group consisting of a vibration action, a rotation action, a linear movement action and the combination thereof, but is not limited thereby.

In an exemplary embodiment, the balance controlling unit 22 is configured with at least a rotor that the number of the rotor required in dependent upon how many different directional balance output with respect to different axial direction is needed. In the embodiment shown in FIG. 2, there are three rotors 220 and each of which is connected to a stabilization unit 23 disposed at a side of the actuator 21 by an end thereof while coupling to a corresponding driving unit 221 by another end thereof for receiving the driving force of the driving unit 221 so as to drive the rotor 220 to rotate. It is noted that the driving unit 221 can be a motor or a servo motor, but is not limited thereby. In this embodiment, each rotor 220 is composed of a shaft 2200 and a wheel 2201, in which the shaft 2200 is connected to the stabilization unit 23 by an end thereof; and the wheel 2201 is connected to an end of the shaft 2200 other than that connecting to the stabilization unit 23 for enabling the wheel 2201 to be driven to rotate by the corresponding driving unit 221. The stabilization unit 23 can be made of a rigid material to be used for fixing the shaft 2200. It is noted that the stabilization unit 23 can be manufactured as a component of the actuator 21, such as the shell of the actuator, but is not limited thereby.

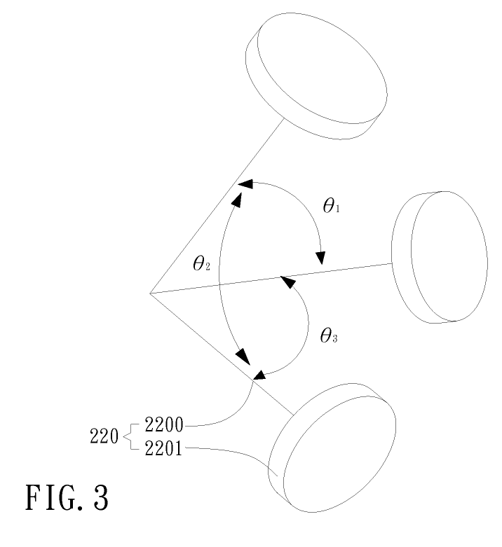

The combination of the balance controlling unit 22 can be various. For instance, there can be a balance controlling unit with one-axial, two-axial or tri-axial configurations for providing one-axial, two-axial or tri-axial balance outputs. In the embodiment shown in FIG. 2, it is a balance controlling unit with tri-axial configuration capable of generating three directional balance output that are orthogonal with each other, in which the balance output is used for generating a response selected from the group consisting of a reactive force and a torque. It is noted that, instead of the orthogonal axial configuration for generating orthogonal balance outputs, the balance controlling unit 22 with tri-axial configuration can be configured in a manner that the included angle formed between any two neighboring axles is not a right angle, i.e. θ₁, θ₂, and θ₃≠90° as shown in FIG. 3. Such configuration is adopted for effectively generating an inertial force with specific direction and magnitude for balancing the reactive force generated by the actuator 21.

In FIG. 2, there are two sensors 24, 25 being mounted respectively on the balance controlling unit 22 and the stabilization unit 23 that are used for detecting the rotation or displacement of the two in respective and thus generating detection signals to a computing unit 26 accordingly. As the computing unit 26 is connected to the actuator 21 and the balance controlling unit 22, the computing unit 26 not only can control the feedback output of the actuator 21 and the balance output of the balance controlling unit 22, it can also perform a feedback control upon the actuator 21 and the balance controlling unit 22 according to the detection signals of the two sensors 24, 25. It is noted that the controlling of the computing unit 26 employs applications of common control theorems and is known to those skilled in the art, thus it is not described further herein.

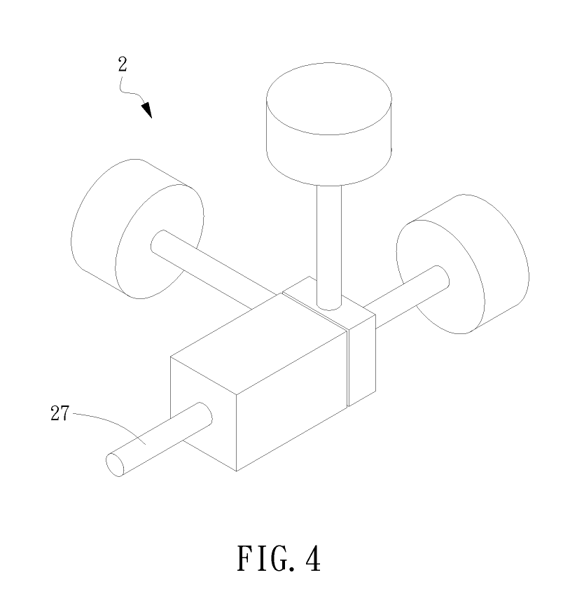

Please refer to FIG. 4, which is a schematic view of a force feedback apparatus according to a second embodiment of the invention. The structure of the force feedback apparatus is about the same as that shown in FIG. 2, but is different in that: the feedback output in FIG. 4 is not exerting on the housing as that is in FIG. 2, but it is on an operating unit 27 of the actuator 21, such as the interface units of joystick or driving wheel, etc. For instance, the feedback output of the actuator 21 is transmitted to a joystick where it is felt by a user holding the joystick. It is noted that, other than the operating unit 27, the force feedback apparatus of FIG. 4 is structured the same as that shown in FIG. 2, and thus is not described further herein.

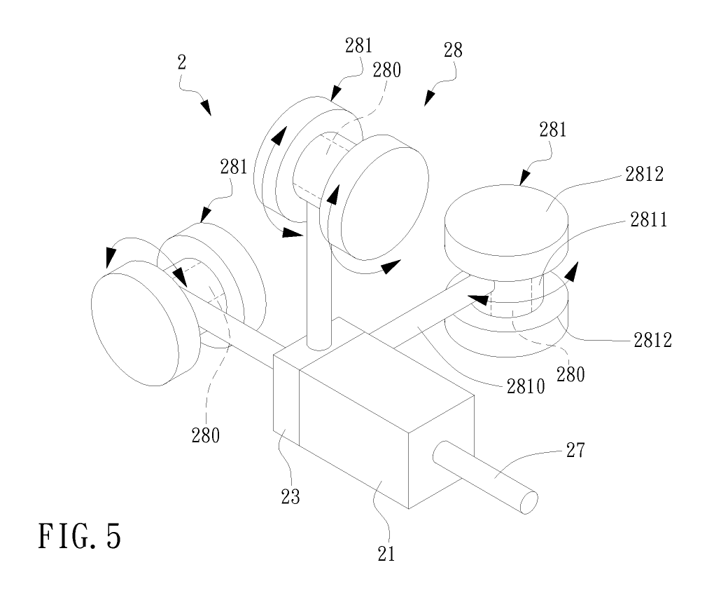

Please refer to FIG. 5, which is a schematic view of a force feedback apparatus according to a third embodiment of the invention. The force feedback apparatus in this embodiment is characterized in its balance controlling unit 28. In this embodiment, the balance controlling unit 28 is configured with three driving units 28, each connecting to a corresponding rotor 281 or enabling the rotor 281 to receive the driving force of the driving unit 221 and thus rotate, whereas each rotor 281 is connected to a stabilization unit 23. Moreover, each rotor 281 is composed of a shaft 2810 and a rotary unit, in which the shaft 2810 is connected to the actuator 21 by an end thereof; and the rotary unit is connected to an end of the shaft 2200 other than that connecting to the actuator 21. The rotary unit is further comprised of a rotary axle 2811 and a pair of wheels 2812, in which the rotary axle 2811 is connected to the shaft 2810 and configured for receiving the corresponding driving unit 280 therein; and the pair of wheels 2812 are disposed at two sides of the rotary axle 2811 in respective. Other than the aforesaid configuration, the rotary unit, connected to an end of the shaft 2810 other than that connecting to the actuator 21, can be configured for using the corresponding driving unit 280 as its rotary axle while having two wheels disposed at the front and rear sides of the corresponding driving unit in respective. It is noted that, other than the aforesaid balance controlling unit 22, the force feedback apparatus of FIG. 5 is structured the same as the foregoing embodiments, and thus is not described further herein.

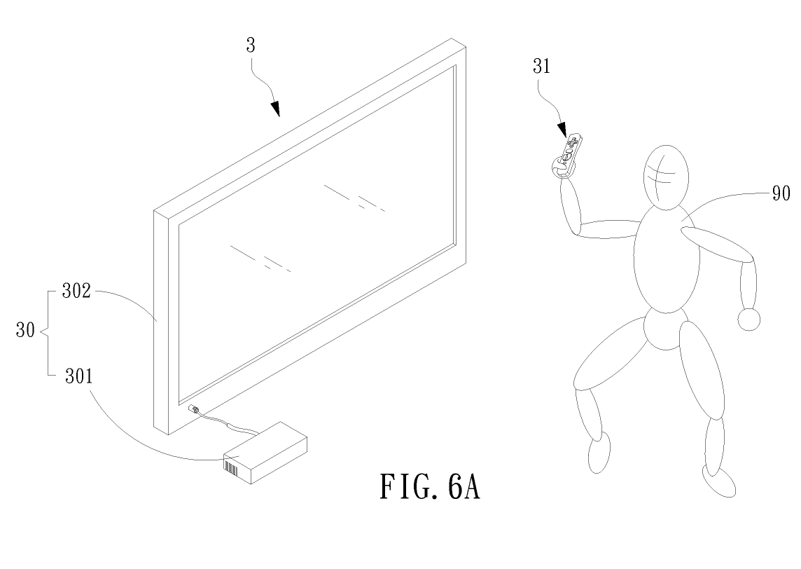

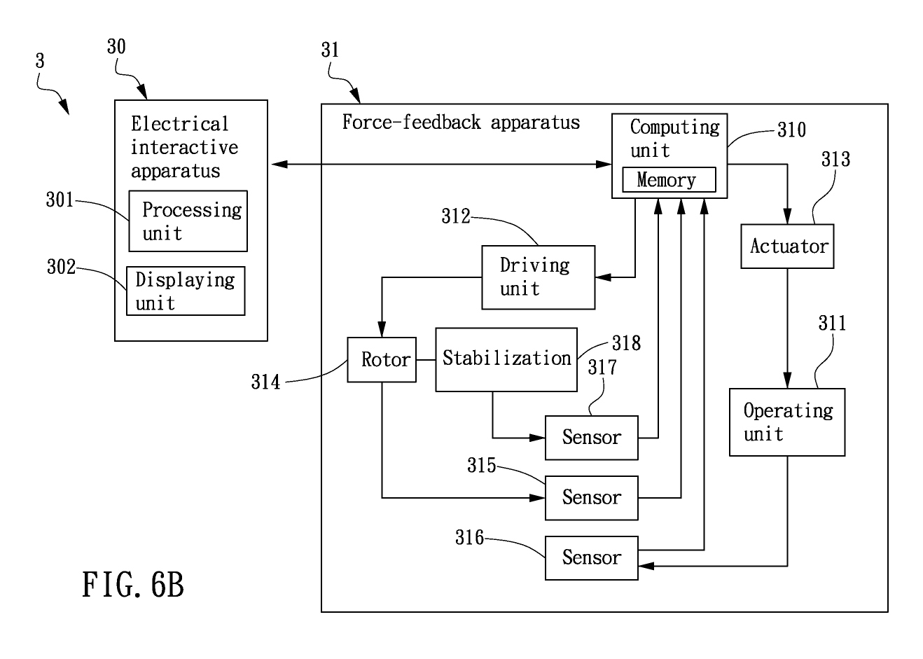

Please refer to FIG. 6A and FIG. 6B, which are respectively a schematic view of a force feedback system of the invention and a block diagram showing a force feedback system according to an embodiment of the invention. In FIG. 6A, the force feedback system 3 includes an electrical interactive apparatus 30 and a force feedback apparatus 31, in which the electrical interactive apparatus 30 further comprises a processing unit 301 and a displaying unit 302 connecting to the processing unit 301. It is noted that the processing unit can be a computer or a game console. As shown in FIG. 6A, a user 90 is able to interact with the electrical interactive apparatus 30 by holding the force feedback apparatus 31 in his/her hand. Such force feedback apparatus can be any one force feedback apparatus shown in the aforesaid embodiments, and thus is not described further herein.

Please refer to FIG. 6B, which is a block diagram showing a force feedback system according to an embodiment of the invention. The force feedback apparatus 31, being configured with a computing unit 310, is able to interact with the user 90 through the operating unit 311, in which the operating unit 311 can be configured as the housing of the handheld video game controller, the housing of a mouse device, joystick, driving wheel or portable computer, etc, but is not limited thereby. In certain actual application, the computing unit is configured with a memory module, such as RAM or ROM, so as to enhance its computation ability. In addition, the processing unit 301 is designed to perform specific high-end operations and is able to communicate with the computing unit 310 at any time by a wired or wireless manner. Moreover, the computing unit 310 is used for executing internal logistic operations of the force feedback apparatus 31.

In the force feedback apparatus 31, the computing unit 310 issues commands to the driving unit 312 and the actuator 313 for directing the driving unit 312 to drive the rotor 314 to rotate and the actuator 313 is output force feedback to the operating unit 311. Moreover, the sensor 315 is used for detecting the rotation speed of the rotor 314; the sensor 316 is used for detecting the movement statuses of the operating unit 311, such as its displacement; and the sensor 317 is used for detecting the movement statuses of the stabilization unit 318, such as its displacement. The sensors 315, 316 and 317 will transmit their detections to the computing unit 310 to be used as basis for controlling the driving unit 312 and the actuator 313. It is noted that the controlling of the computing unit 310 employs applications of common control theorems and is known to those skilled in the art, thus it is not described further herein.

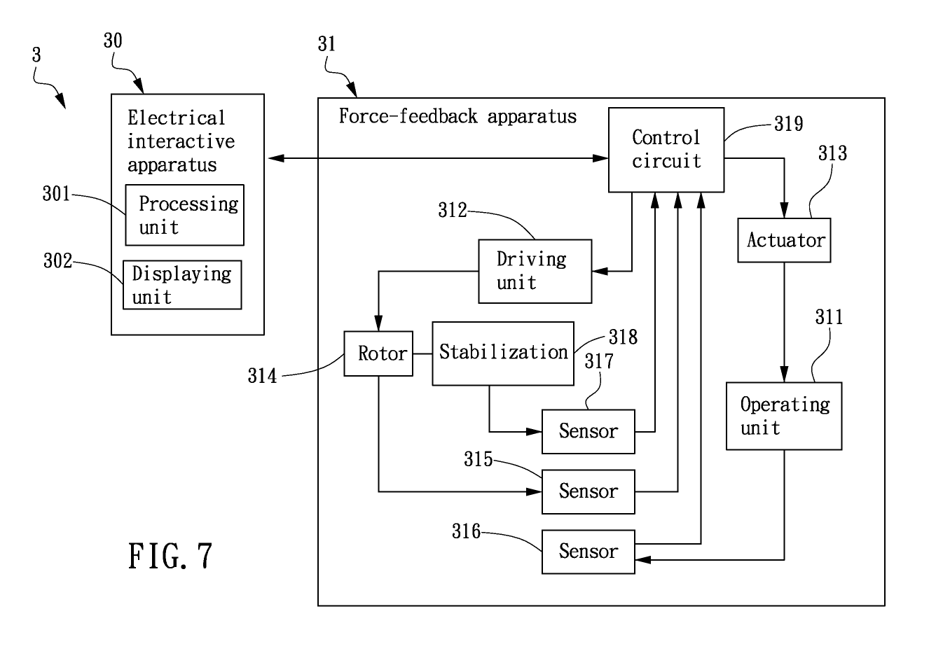

Please refer to FIG. 7, which is a block diagram showing a force feedback system according to another embodiment of the invention. In this embodiment, there is no computing unit being configured in the force feedback apparatus 31, instead all the computations are carried out by the processing unit 301 configured in the electrical interactive apparatus 30. Thus, there is a control circuit 319 being configured in the force feedback apparatus 31 to be used for receiving signals transmitted directly from the electrical interactive apparatus 30 so as to direct the driving unit 312 for driving the rotor 314 to rotate. Similarly, the sensors 315, 316 and 317 will transmit their detections to the control circuit 319 to be used as feedback control basis.

As shown in FIG. 6A and FIG. 6B, a game environment is displayed on the displaying unit 302 of the electrical interactive apparatus 30 which is programmed to respond to any input issued by the user 90 holding the force feedback apparatus 31. When the user 90 issue an input through the operating unit 311, such input is transmitted to the electrical interactive apparatus 30 by the force feedback apparatus 31. When the game responds to such input as the processing unit 301 issues a force feedback command, such force feedback command is send to the force feedback apparatus 31 for directing the computing unit 310 to control the rotation of the rotor 314 and the operation of the actuator 313 with respect to the direction and magnitude of reactive force, thereby, the feedback output of the actuator 21 is transmitted to a operating unit 311 where it is felt by the user 90. In order for the actuator to function accurately, the rotation of the rotor 314 should be precisely control for generating an inertial force just enough to enable the stabilization unit 318 to achieve balance so as to balance the reactive force of the actuator 313. It is noted that the use of the to rotating rotor 314 to achieve force balance employs applications of common control theorems and is known to those skilled in the art, thus it is not described further herein.

To sum up, the present invention provides a force feedback apparatus capable of balancing the reactive force or torque generated by an actuator of the force feedback apparatus through a balance output generated by a balance controlling unit coupled to the actuator so that the force feedback apparatus can interactive with the operator without a need for connection to a fixed frame.

The invention being thus described, it will be obvious that the same may be varied in many ways. Such variations are not to be regarded as a departure from the spirit and scope of the invention, and all such modifications as would be obvious to one skilled in the art are intended to be included within the scope of the following claims.

What is claimed is:

1. A force feedback apparatus, comprising:
an actuator, for providing a feedback output;
an operating unit, coupled to the actuator for receiving the feedback output; and
a balance controlling unit, coupled to the actuator for generating a balance output to balance the force generated by the feedback output.

2. The force feedback apparatus of claim 1, wherein the feedback output is able to cause a response selected from the group consisting of a vibration action, a rotation action, a linear movement action and the combination thereof; while the balance output is used for generating a response selected from the group consisting of a reactive force and a torque.

3. The force feedback apparatus of claim 1, wherein the balance controlling unit further comprises:
at least a driving unit; and
at least a rotor, each coupled to the actuator by an end thereof while coupling to the a corresponding driving unit selected from the at least one driving unit by another end thereof in a manner that rotor receives a driving force from the coupled driving unit and thus rotates.

4. The force feedback apparatus of claim 3, wherein the actuator is connected to the at least one rotor by way of a stabilization unit while the stabilization unit is further coupled to a first sensor in a manner that the first sensor is able to detect operation statuses of the stabilization unit.

5. The force feedback apparatus of claim 3, further comprising:
at least a second sensor, each coupled to a corresponding rotor selected from the at least one rotor in a manner that each second sensor is able to detect operation statuses of its corresponding rotor.

6. The force feedback apparatus of claim 3, wherein each rotor further comprises:
a shaft, connected to the actuator by an end thereof; and
a wheel, connected to an end of the shaft other than that connecting to the actuator for enabling the wheel to be driven to rotate by the corresponding driving unit.

7. The force feedback apparatus of claim 3, wherein each rotor further comprises:
a shaft, connected to the actuator by an end thereof; and
a rotary unit, connected to an end of the shaft other than that connecting to the actuator, further comprising:
a rotary axle, connected to the shaft and configured for receiving the corresponding driving unit therein; and
a pair of wheels, being disposed at two sides of the rotary axle in respective.

8. The force feedback apparatus of claim 3, wherein each rotor further comprises:
a shaft, connected to the actuator by an end thereof; and
a rotary unit, connected to an end of the shaft other than that connecting to the actuator, configured for using the corresponding driving unit as its rotary axle while having two wheels disposed at the front and rear sides of the corresponding driving unit in respective.

9. The force feedback apparatus of claim 1, further comprising:
a third sensor, electrically connected to the operating unit in a manner that the third sensor is able to detect operation statuses of the operating unit.

10. The force feedback apparatus of claim 1, further comprising:
a computing unit, coupled to the actuator and the balance controlling unit.

11. The force feedback apparatus of claim 10, further comprising:
a control circuit, coupled to the actuator and the computing unit.

12. The force feedback apparatus of claim 1, wherein the operating unit is a device selected from the group consisting of a mouse housing, a game board, a housing of a handheld joystick, and a portable computer.

13. A force feedback system, comprising:
an electrical interactive apparatus; and
a force feedback apparatus, capable of communicating with the electrical interactive apparatus, further comprising:
an actuator, for providing a feedback output;
an operating unit, coupled to the actuator for receiving the feedback output; and
a balance controlling unit, coupled to the actuator for generating a balance output to balance the reactive force generated by the feedback output.

14. The force feedback system of claim 13, wherein the electrical interactive apparatus further comprises: a processing unit, being a device selected form the group consisting of a computer and a game console; and a display unit, connecting to the processing unit; and the operating unit is a device selected from the group consisting of a mouse housing, a game board, a housing of a handheld joystick, and a portable computer.

15. The force feedback system of claim 13, wherein the feedback output is able to cause a response selected from the group consisting of a vibration action, a rotation action, a linear movement action and the combination thereof; while the balance output is used for generating a response selected from the group consisting of a reactive force and a torque.

16. The force feedback system of claim 13, wherein the balance controlling unit further comprises:
at least a driving unit; and
at least a rotor, each coupled to the actuator by an end thereof while coupling to the a corresponding driving unit selected from the at least one driving unit by another end thereof in a manner that rotor receives a driving force from the coupled driving unit and thus rotates.

17. The force feedback system of claim 16, wherein the actuator is connected to the at least one rotor by way of a stabilization unit while the stabilization unit is further coupled to a first sensor in a manner that the first sensor is able to detect operation statuses of the stabilization unit.

18. The force feedback system of claim 16, further comprising:
at least a second sensor, each coupled to a corresponding rotor selected from the at least one rotor in a manner that each second sensor is able to detect operation statuses of its corresponding rotor.

19. The force feedback system of claim 16, wherein each rotor further comprises:
a shaft, connected to the actuator by an end thereof; and
a wheel, connected to an end of the shaft other than that connecting to the actuator for enabling the wheel to be driven to rotate by the corresponding driving unit.

20. The force feedback system of claim 16, wherein each rotor further comprises:
a shaft, connected to the actuator by an end thereof; and
a rotary unit, connected to an end of the shaft other than that connecting to the actuator, further comprising:
a rotary axle, connected to the shaft and configured for receiving the corresponding driving unit therein; and
a pair of wheels, being disposed at two sides of the rotary axle in respective.

21. The force feedback system of claim 16, wherein each rotor further comprises:
a shaft, connected to the actuator by an end thereof; and
a rotary unit, connected to an end of the shaft other than that connecting to the actuator, configured for using the corresponding driving unit as its rotary axle while having two wheels disposed at the front and rear sides of the corresponding driving unit in respective.

22. The force feedback system of claim 13, further comprising:
a third sensor, electrically connected to the operating unit in a manner that the third sensor is able to detect operation statuses of the operating unit.

23. The force feedback system of claim 13, further comprising:
a computing unit, coupled to the actuator and the balance controlling unit.

24. The force feedback system of claim 23, further comprising:
a control circuit, coupled to the actuator and the computing unit while the computing unit is further coupled to a memory module.
